(19) United States
(12) Patent Application Publication
(10) Pub. No.: US 2002/0177466 A1
(43) Pub. Date: Nov. 28, 2002

(54) Call control for user equipment

(76) Inventors: Pasi Laurila, Tupos (FI); Jussi Niskanen, Kempele (FI); Timo Ali-Vehmas, Salo (FI); Juha Timonen, Oulu (FI); Mikko J. Rinne, Helsinki (FI); Juhani Latvakoski, Sankoniementie (FI)

Correspondence Address: PERMAN & GREEN, 425 POST ROAD, FAIRFIELD, CT, 06824, US

(21) Appl. No.: 10/139,856

(22) Filed: May 6, 2002

(30) Foreign Application Priority Data
May 9, 2001 (FI) 20010979

(51) Int. Cl. H04B 1/38

(52) U.S. Cl. 455/552; 455/550

(57) ABSTRACT

The invention relates to user equipment, which is adapted to use more than one access type for communicating with radio systems. After a service requiring a connection between the user equipment and the radio system has been activated, the suitability of the user equipment's current access type for the operation of the activated service is checked and access type re-selection is carried out, in response to the check, to select an access type suitable for the service.

### FIELD OF THE INVENTION

The invention relates to a call control concerning the changing of user equipment access type. The invention particularly relates to user equipment capable of using more than one access type when communicating with radio systems.

### BACKGROUND OF THE INVENTION

The digital radio systems widely used today are commonly referred to as second generation systems, first generation systems being analog systems, which have gradually become less common. The new third generation radio systems that are currently being developed are designed to enable the planning and building of user equipment capable of setting up a connection and communicating with both second and third generation systems without any difficulties.

To communicate with a radio system, user equipment employs an access type. Earlier systems applied system-specific access types, and usually no other alternatives were available. As more sophisticated systems have been developed, it has become possible to use more than one access type to communicate with a system. In this context, the term ‘access type’ refers to two both radio access and network access types.

Radio systems may employ a plural number of different radio access types (or Radio Access Technologies, RATs), such as the second generation GSM (Global System for Mobile Communication) and the UTRA of the third generation UMTS (Universal Mobile TeleCommunication System). These two serve as examples of technologies that are highly compatible, even to such an extent that handover between them can be carried out without the call or connection being thereby dropped. Other methods for implementing the radio path include Bluetooth and WLAN. There is great variation in transmission capacity and coverage from one access type to another. Consequently, the different access types can be used for providing most diversified services.

The term ‘network access type’ refers to the network solution behind the radio interface. A terminal may use different radio access types in one and the same network solution to communicate with a system. This is illustrated, by way of example, in FIG. 1A. User equipment 100 may communicate with a system 102 using two network access solutions 104, 106, such as third generation 3GPP Release 99, Release 4, Release 5, both in the packet-switched and circuit-switched domain, GSM or 3GPP2. Both network access types can communicate with a plural number of radio access types 108-114, such as GSM 450, GSM 900, GSM 1800, UMTS, WLAN, Bluetooth, etc.

When the user equipment is switched on, it attempts to set up a connection to a radio system (PLMN, Public Land Mobile Network). The radio system is selected either automatically or manually. The user equipment usually has a default radio system which it tries to contact first. On the other hand, when the user equipment is outside the coverage area of its default radio system, abroad for example, it must select the system it wishes to access. In addition to the radio system, the user equipment also selects the access type, i.e. the radio access type and the network access type that it employs to access the system. The user equipment searches for a radio system cell to camp on to start monitoring the control channel of the cell. To select the radio system and the cell, the user equipment maintains a list of radio systems and their access types. The list is typically stored in the USIM or SIM card of the user equipment.

The user equipment carries out occasional quality measurements of its cell and other cells, especially when it is in an idle mode, i.e. when there is no ongoing active call, for example. If the user equipment detects another cell that provides a connection of better quality than the cell it is currently using, the user equipment may carry out a cell selection procedure and change the cell, i.e. it may perform cell re-selection, or a cell re-selection between radio access systems may be performed. The user equipment often carries out the measurements using control channels of cells, and measurements of signal strength or signal-to-interference ratio may be included therein. In other words, the selection of a cell takes place on the basis of quality measurements.

Current and future radio systems offer various services to the users, such as ordinary calls, browsing of the Internet, video viewing, and for example applications that can be downloaded to the user equipment from the network, such as Java applications, etc. These services differ in their data transmission capacity requirements, delay tolerances, prices and other characteristics. Some services employ several radio access types, others only some. For example, the transfer of video image functions poorly with the GSM access type because of its relatively low data transfer capacity, whereas with the UTRA access type the service functions better. In a prior art solution, when a user activates a service, a connection is set up to a base station and if the system then detects for example that its current access type is not capable of providing the desired service, handover between cells of different access types is carried out during the connection. This kind of handover loads the system and causes a brief break in the connection, which is why it is a non-desirable feature from the user's point of view.

### BRIEF DESCRIPTION OF THE INVENTION

It is an object of the invention to provide an equipment to allow the above mentioned problems to be solved. This is achieved with user equipment comprising means for employing more than one access type to communicate with radio systems; means for activating a service requiring a connection between the user equipment and a radio system; means for checking the suitability of the user equipment's current access type for the operation of the activated service; and means for carrying out a re-selection of access type, in response to the check, to select an access type suitable for the service.

The preferred embodiments of the invention are disclosed in the dependent claims.

An underlying idea of the invention is to maintain information about services and their preferred access types. When the user activates a service at his/her user equipment, or when the system sends a service request to the user equipment, the invention allows the current access type of the user equipment to be checked. If it turns out that there is another access type available that would be better for the selected service, a change of access type can be carried out.

When necessary, cell re-selection can be carried out to select a cell in which the better radio access type is used. It is also possible to only carry out the selection of the access type if the cell where the user equipment is camped on supports several access types among which there is one that is suitable for the activated service.

In this context, ‘selection of access type’ refers to the changing of radio access type and/or network access type.

In a preferred embodiment of the invention, the user equipment maintains a list to allow a radio system and a cell to be selected, the list also comprising services and parameters influencing the selection of the cell for a particular service. When a service is activated, a cell selection parameter relating to the service is read from the list, the parameter being meant to influence the cell selection algorithm such that from the beginning of the connection, the user equipment is in a radio access system cell where the service functions well. The list may also include network access types suitable for a particular service and/or parameters influencing their selection, such as information about prices.

In another preferred embodiment, the user equipment informs a telecommunications system that a service is activated in the user equipment. The system checks the access type that is best suited for the service concerned and informs the user equipment whether the current access type needs to be changed. After having received the information, the user equipment may perform access type re-selection, if necessary.

In a further preferred embodiment, when the user equipment registers in the system, it informs its current access type to the system. Hence, if there is a service request from the telecommunications system, the system is able to directly check, without any exchange of messages, the access type that suits best the service concerned and to inform the user equipment whether it needs to change its current access type. After having received the information, the user equipment may perform access type re-selection, if necessary.

The solutions according to the preferred embodiments of the invention provide several advantages. Since the suitability of the access type is checked at the time a service is being selected, the user equipment may change the access type and possibly the cell, if necessary, already before the actual connection set-up. Consequently, the user equipment does not need to carry out handover between radio access types, for example, during the connection. The changing of the cell and the access type prior to the connection set-up, i.e. in the idle mode, is a faster and lighter process than handover from one access type to another during the connection. For the user this means faster activation of the service, and, since the appropriate cell for the service is used right from connection set-up, the service functions well from very beginning.

The selection of the cell selection parameter value used in the solution of the first preferred embodiment with regard to a service may depend on several aspects. Different parameter values may be provided for different radio systems. In other words, depending on the system employed at the time a service is activated, a corresponding parameter is read from the memory. The parameter may be selected according to the data transmission capacity required by the service. This means that when the system in question is GSM, the parameter would influence the cell selection algorithm such that the user equipment would move to a cell located in a system providing higher capacity, such as the UTMS. The parameter may also be selected according to the price of the service, for example. Different services may be priced differently in different systems. The impact of the parameter on the cell selection algorithm may be shown in that the user equipment would move to a cell located in a system offering the user the lowest price quotation for the service.

In a solution according to yet another preferred embodiment, aspects similar to those described above may be taken into account when decisions are taken with regard to the selection of service/access type information maintained by the system.

Moreover, the above described embodiments may be applied simultaneously. In that case, after having checked the access type and performed the necessary cell re-selection, if any, the user equipment informs the system about a service to be activated and the access type used. The system then checks, on the basis of its information, the suitability of the access type.

### BRIEF DESCRIPTION OF THE DRAWINGS

In the following the invention will be described in greater detail in connection with preferred embodiments and with reference to the accompanying drawings, in which

FIG. 1A illustrates already described examples of access types;

FIG. 1B illustrates other examples of access types;

FIG. 1C illustrates an example of a radio system;

FIG. 2 illustrates a more detailed example of a radio system;

FIG. 3 illustrates an example of user equipment;

FIG. 4 illustrates another example of user equipment;

FIG. 5 illustrates a list of services maintained by the user equipment;

FIG. 6 is a flow diagram illustrating the operation of the user equipment in a preferred embodiment; and

FIGS. 7A-7C are signal diagrams illustrating some preferred embodiments.

### DETAILED DESCRIPTION OF PREFERRED EMBODIMENTS

As already stated, the invention can be applied in user equipment capable of using more than one access type for communicating with a radio system. In this context, ‘access types’ refer to both radio access and network access technologies. In the following, preferred embodiments will be described using radio access types GSM and the UTRA of the UMTS as examples, but a person skilled in the art will find it apparent that the invention is not restricted to these.

First, let us make a few clarifying terminology remarks. In the examples of the present application, a radio system, i.e. the PLMN, refers to a radio system maintained by an operator and implemented by means of cells using the GSM and UTRA radio access types. In other words, the network cells employ either the GSM or the UTRA of the UMTS as their Radio Access Technologies (RAT), the coverage areas of cells using different access types overlapping at least in some parts of the system, whereby cell handover from a cell using one access type to a cell using another is possible without the connection being thereby dropped.

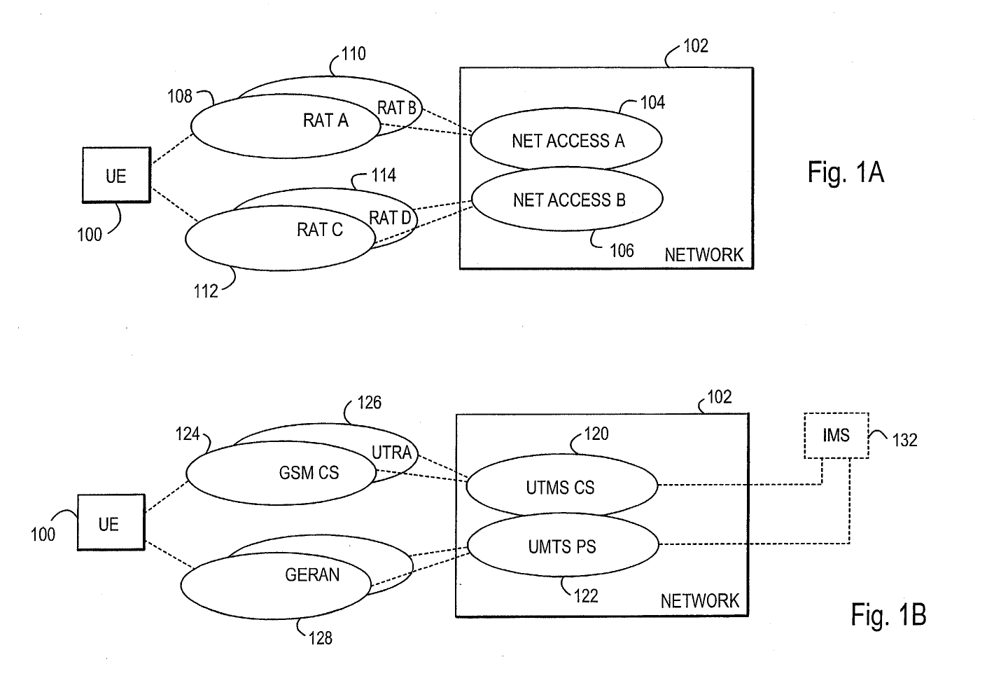

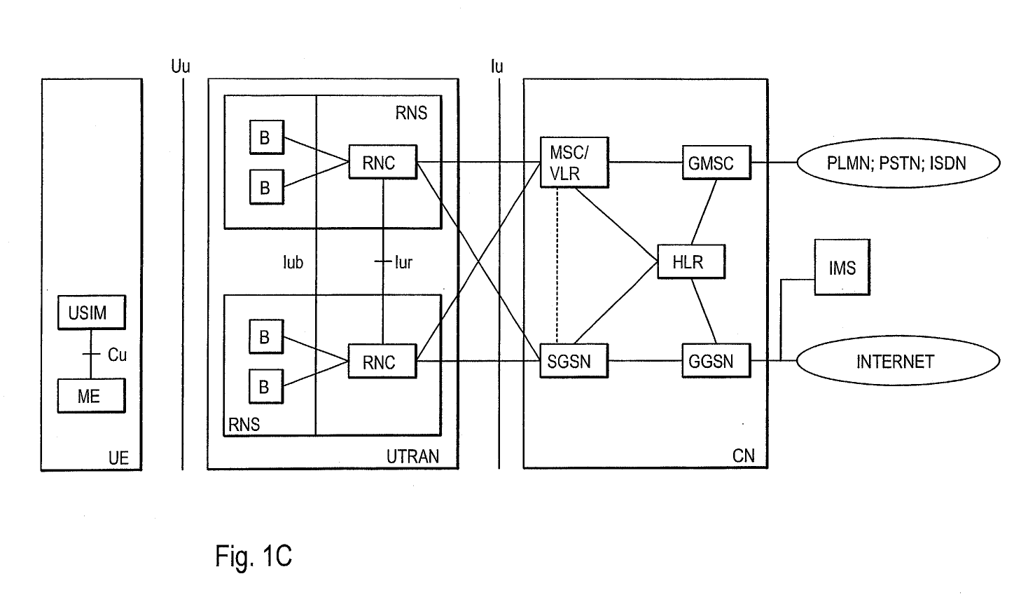

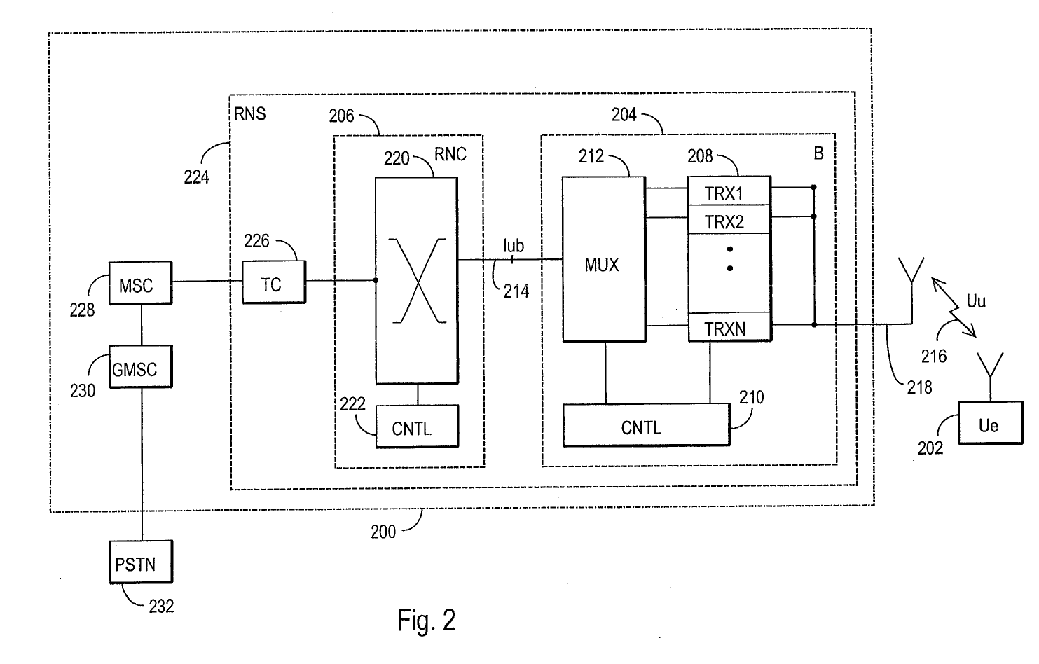

Let us examine FIG. 1B which specifies the example of FIG. 1A according to the embodiment to be described below. In FIG. 1B, the user equipment 100 may communicate with the system 102 using both GSM access type 124 and UTRA access type 126. In this example, both of these use the same network access type 120. There is a further connection from the radio network to an IP Multimedia Subsystem IMS 132 which provides the system with multimedia services. The user equipment may also use other access types, such as the packet-switched GERAN, or some other radio access type 130, and it can also communicate with the network by using some other network access type 122. The cited access types serve, however, only as examples, which will be apparent to a person skilled in the art.

With reference to FIG. 1C, the structure of a UMTS mobile communication system will be disclosed by way of example. The main elements of the mobile communication system are a core network CN, a UMTS terrestrial radio access network UTRAN, and user equipment UE. The interface between the core network CN and the radio access network UTRAN is called Iu and the air interface between the UTRAN and the UE is called Uu.

The user equipment UE consists of two parts: mobile equipment ME, which comprises a radio terminal used for setting up a radio connection over the interface Uu, and a UMTS Subscriber Identity Module USIM, which is a smart card comprising user identity information and which typically executes identification algorithms, stores ciphering parameters and subscriber data.

The UTRAN is formed of radio network subsystems RNS. An RNS is composed of a radio network controller RNC and one or more nodes B. In practice, node B is a base station. With the base stations connected thereto, the radio network controller RNC manages the radio resources.

The core network CN comprises a plural number of elements. A Home Location Register HLR is a database in the subscriber's home system which maintains the user's service profile. The home location register also maintains user location information with MSC accuracy. A Mobile Services Switching Centre/Visitor Location Register MSC/VLR provides a switch (MSC) and database (VLR) serving the user equipment with regard to Circuit-Switched (CS) services. The MSC switches circuit-switched services and the VLR maintains user profile and location information. A Gateway MSC GMSC in turn is a switch that connects the UMTS with external services and networks. All circuit-switched connections are routed via a GMSC. The functionality provided by a Serving GPRS (General Packet Radio Service) Support Node corresponds to that provided by the MSC/VLR, except that it used for routing packet-switched (PS) connections. Correspondingly, the functionality of a Gateway GPRS Support Node GGSN corresponds to that of the GMSC, except that it relates to packet-switched connections. External networks can be divided into two types: circuit-switched networks, such as the existing telephone networks, and packet-switched networks, such as the Internet.

FIG. 1B also shows an IP Multimedia Subsystem IMS which provides the radio system with multimedia services which are usually, although not necessarily, Internet-based services employing a packet protocol. The IMS can be advantageously implemented for example with a computer and software.

The UMTS comprises a plural number of defined interfaces. Cu is an interface between the smart card USIM and the mobile equipment ME. Uu is a radio interface between the user equipment and a base station. The interface between the core network CN and the radio access network UTRAN is Iu. The interface between the radio network subsystems RNS is called Iur. This allows soft handover operations to be carried out between radio network controllers of different manufacturers. The interface between the radio network controller RNC and a base station B is called Iub.

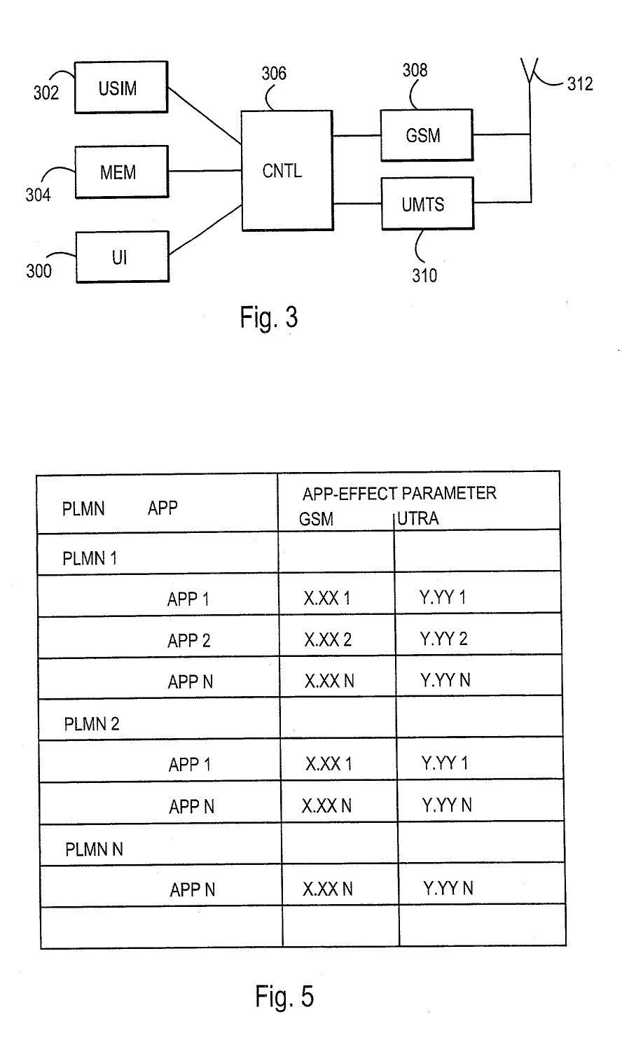

FIG. 1 provides an illustration of a fairly general level, and it is therefore clarified with a more detailed example of a cellular radio system shown in FIG. 2. FIG. 2 only shows the most essential blocks, but a person skilled in the art will find it apparent that a conventional cellular radio network also comprises other functions and structures, which need not be described in greater detail herein. It should also be noted that the structure shown in FIG. 2 provides only one example. The systems of the invention may differ from those shown in FIG. 2 in their details, but such differences are not relevant to the invention.

The cellular radio network thus typically comprises a fixed network infrastructure, i.e. a network part 200, and user equipment 202, such as fixedly mounted, vehicle-mounted, or handheld terminals. The network part 200 comprises base stations 204. A base station corresponds to the node B in the previous Figure. A plural number of base stations 204 are in turn controlled in a centralized manner by a radio network controller 206 communicating with the base stations. A base station 204 comprises transceivers 408 and a multiplexer 212.

The base station 204 further comprises a control unit 210 which controls the operation of the transceivers 208 and the multiplexer 212. The multiplexer 212 is used for arranging the traffic and control channels used by a plural number of transceivers 208 on one transmission link 214, which forms the interface Iub.

From the transceivers 208 of the base station 204 there is a connection to an antenna unit 218 which provides a bi-directional radio link 216 to the user equipment 202. The structure of the frames transferred on the bi-directional radio link 216 are defined for each system separately and the link is referred to as air interface Uu. In the preferred embodiments of the invention, at least some of the signals are transmitted using three or more transmit antennas, or three or more beams produced by means of several transmit antennas.

The radio network controller 206 comprises a group switching field 220 and a control unit 222. The group switching field 220 is used for switching speech and data and for connecting signalling circuits. The radio network subsystem 224 formed by the base station 204 and the radio network controller 206 further comprises a transcoder 226. The transcoder 226 is usually located as close to the mobile services switching centre 228 as possible because speech can then be transferred between the transcoder 226 and the radio network controller 206 in a cellular radio network form, which saves transmission capacity.

The transcoder 226 converts different digital speech coding formats used between the public switched telephone network and the radio telephone network to make them compatible, for example from a fixed network format to another format in the cellular network and vice versa. The control unit 222 carries out call control, mobility management, collection of statistical data and signalling.

FIG. 2 further illustrates the mobile services switching centre 228 and the gateway mobile services switching centre 230 which is responsible for the external connections of the mobile communications system, in this case for those to the public switched telephone network 232.

A system part implemented using the GSM system corresponds basically to the above described UMTS system and need not therefore be separately described in greater detail herein. However, some differences in terminology are worth mentioning: for example, the terms corresponding to the USIM and RNC used in the UMTS are SIM and BSC in the GSM. Since different systems are concerned, there are naturally functional differences as well, but they do not need to be described in this context.

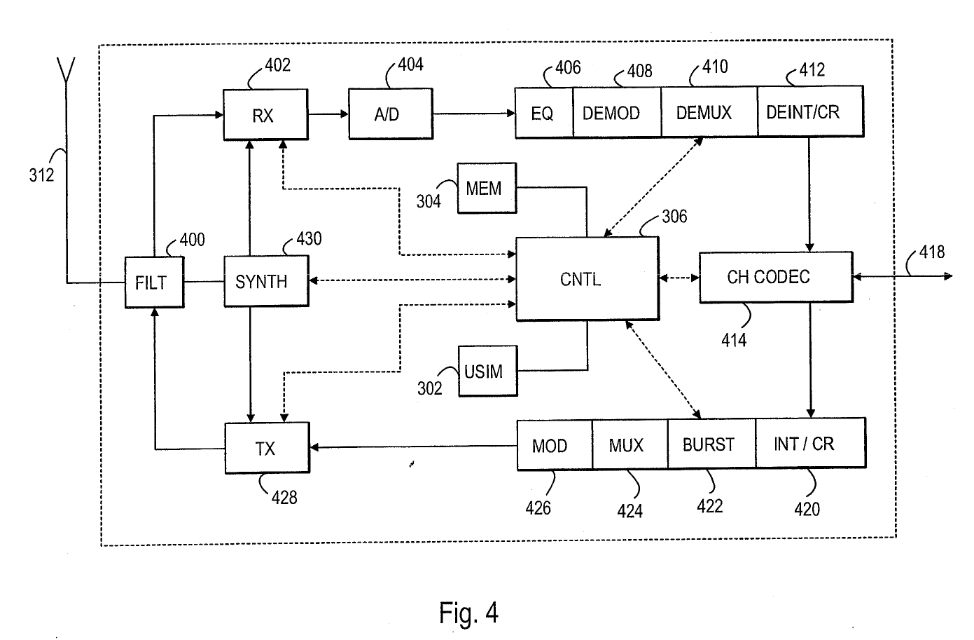

Let us then examine a simplified example of user equipment of some of the preferred embodiments according to the invention with reference to FIG. 3. The Figure shows a schematic view of a simplified user equipment structure. The user equipment comprises, firstly, a user interface 300, which typically includes a microphone, speaker, keyboard and display. With the user interface, the user communicates with the user equipment. The user equipment further comprises a SIM or USIM card 302 which is a smart card comprising subscriber identity information and which identifies the subscriber connection. The terminal comprises a memory 304 storing software used by the user equipment, such as a telephone directory, and service software that can be run on the user equipment. A control unit 306 of the user equipment is coupled to all the above mentioned components to carry out diverse functions. The control unit controls the operation of the other components and processes received signals and those to be transmitted at the baseband frequency. The control unit comprises a processor and possibly a number of separate components. The physical implementation of the above described components as such is clear to a person skilled in the art, but the software to be executed in the components will be described below.

The user equipment further comprises radio frequency units 308, 310 for both GSM and UMTS access technologies, and an antenna 312 for transmitting and receiving a signal. A baseband signal is supplied from the control unit of the user equipment either to a GSM unit 308 or UMTS unit 310, depending on the system to which the cell currently controlling the user equipment belongs to. The implementation disclosed herein provides only one example of the user equipment structure. For example, from the point of view of the preferred embodiments of the invention it is not relevant how the communications means of the different systems are distributed or implemented in the user equipment. It is fully possible that the units 308 and 310 have common components and elements, and, on the other hand, that the baseband components comprise components specific to one of the systems.

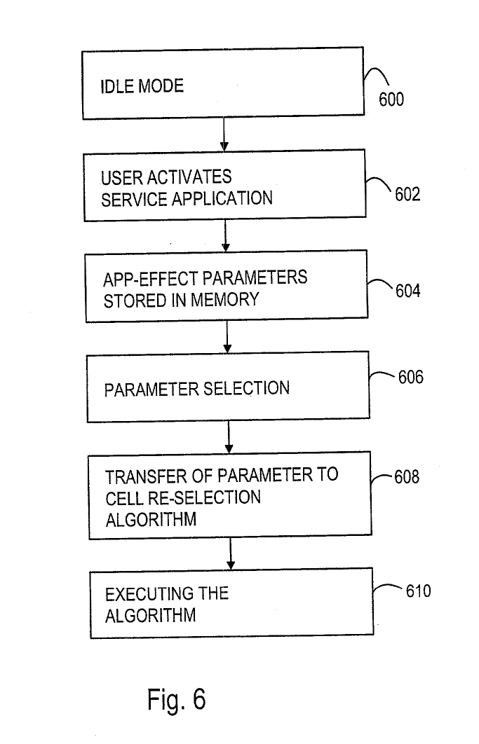

Let us now examine a more detailed example of the user equipment structure with reference to FIG. 4. The terminal shown in FIG. 4 has a structure of a transceiver, and it comprises an antenna 312 for transmitting and receiving a signal. The antenna is connected to a filter 400 separating the transmit and receive frequencies from one another. Let us first examine the structure of the receiver side. From the filter 400, the received signal is supplied to radio frequency parts 402 where the signal is converted to an intermediate frequency or to baseband and amplified. From the radio frequency parts the signal is supplied to an analog-to-digital converter 404 where it is sampled and quantized. The signal is then supplied to an equalizer 406 which compensates for interference caused by multpath propagation, for example. A demulator 408 separates a bit stream from the equalized signal and supplies it to a demultiplexer 410. The demultiplexer 410 separates the bit stream from the different time slots into separate logical channels. The demultiplexed signal is supplied further to a deinterleaver 412 and from there to a channel codec 414 which decodes the bit streams from the different logical channels, i.e. decides whether a bit stream is signalling data, which is supplied to the control unit 306, or whether it is speech, which is supplied 418 further to a speech codec (not shown), for example, or to the user interface of the user equipment. The channel codec 414 also carries out error correction. The control unit 306 performs internal control functions by controlling different units.

On the transmission side, the signal to be transmitted which is received from the channel codec is interleaved in an interleaver 420 and supplied to a burst former 422 which adds a training sequence and a tail to the data received from the channel codec. A multiplexer 424 designates a time slot for each burst. A modulator 426 modulates digital signals onto a radio frequency carrier. A radio frequency transmitter 428 comprises a filter to restrict the bandwidth. In addition, the transmitter 428 controls transmission output power. A synthesizer 430 provides the different units with the necessary frequencies. The synthesizer creates the frequencies that are needed by means of a voltage-controlled oscillator, for example.

The user equipment further comprises a memory 304 connected to the control unit 306, software and data used by the user equipment being stored in the memory, and a USIM card reader 302.

The above described user equipment solution provides only one example. The details of the user equipment structure may differ from the above description, depending on the actual purpose of use of the user equipment. The user interface has been left out of the above described solution because its implementation is not relevant in this connection. In addition, in the above implementation, the alternatives required by the different radio systems are integrated in the user equipment components, i.e. the filter 400 and the radio frequency parts 402 and 428, for example, comprise components capable of both GSM and UMTS connections, and they operate under the control of the control unit 306.

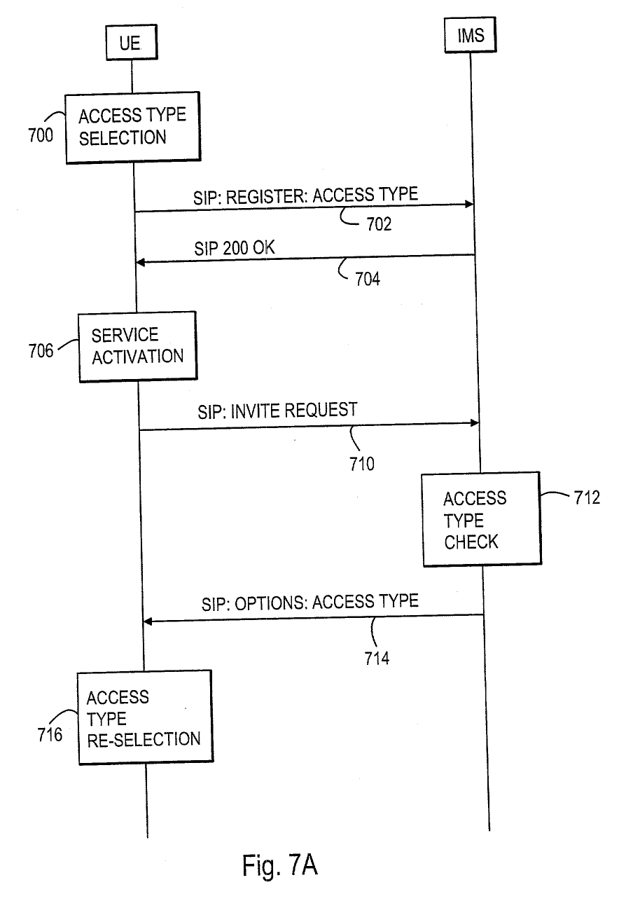

In some preferred embodiments of the invention, the user equipment maintains a list of radio systems and their radio access technologies (RATS) for selecting a radio system and a cell. The list maintained by the user equipment also includes radio system services and parameters affecting the cell selection in connection with each service. The list is typically stored in the USIM or SIM card of the user equipment. In the preferred embodiments of the invention, prior art methods can be applied to produce the list of the radio systems and their radio access types. As regards services, an example of preferred contents of the list is shown in FIG. 5. The list comprises radio system (PLMN) services and, attached to each service, cell selection parameters, which can be determined for each radio access type separately. Let us clarify this with the example shown in FIG. 5 which assumes that the user equipment supports both GSM and UMTS access technologies. Each service therefore has two parameter values in the list, one for a situation where the user equipment is in the GSM system and another for a situation where it is in the UMTS system. The reason for this is that different systems may apply different cell selection algorithms and therefore the parameters must also have different values.

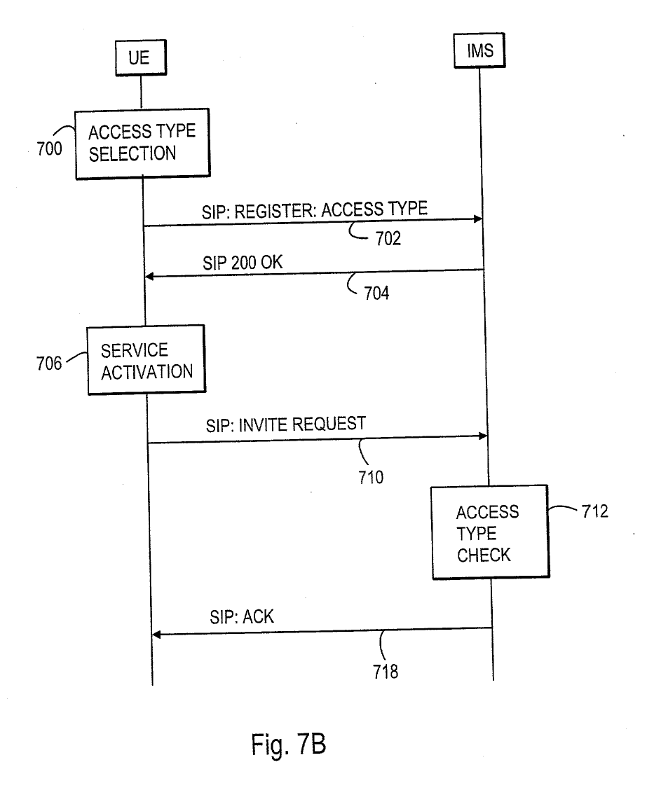

Let us then examine the operation of user equipment according to some preferred embodiments of the invention with reference to a flow diagram shown in FIG. 6. In the first step 600 the user equipment is assumed to be in an idle mode, but still connected to a system and a cell. The user equipment thus occasionally executes the cell re-selection procedure, as described above. The activation of a service may also activate the execution of a cell selection algorithm. The user equipment thus knows the system (PLMN) it is currently residing in and the radio access technology (RAT) that it is using. In step 602 the user activates a service with the user interface 300. In practice, an application needed by the service is activated in the user equipment, i.e. the control unit 306 reads from the memory 304 the service application code and starts to execute it. In step 604, the control unit of the user equipment then reads the cell selection parameters of the service from the USIM card 302, for example. In step 606, the appropriate parameter is selected. The parameter is selected to be such that the PLMN is the one the user equipment is currently connected to and the RAT is the one currently employed.

In a preferred embodiment of the invention, only cell selection parameters of a service just activated are read from a USIM card, for example. In another preferred embodiment, the cell selection parameters of all services are read in step 604 in one go. Correspondingly, in that case a parameter is selected in step 606 such that the PLMN is the one the user equipment is currently connected to, the RAT is the one currently employed and the service is the one to be activated.

In step 608 the selected parameter is supplied to the cell selection algorithm to serve as a parameter. From then on, the cell selection algorithm is thus able to take into account the needs of the activated service with regard to cell.

Let us then examine examples of possible algorithms and cell selection parameters for services. In the UMTS system a cell re-selection criterion H can be determined by applying the following formulae, provided that a cell structure known as a hierarchical cell structure HCS is used:

H_{S}=Q_{Meas}_{_{—}}_{LEV,S}−Qhcs_{S}

Hₙ=(Q_{Meas}_{_{—}}_{LEV,n}−Qhcsₙ−TOₙ*Lₙ)*APP_{—}EFFECT_{UMTS}

Consequently, if Hₛ of a serving cell is lower than Hₙ of another cell, cell re-selection takes place.

If the HCS is not in use, the cell re-selection criterion R can be obtained from the following formula

R_{S}=Q_{map,s}+Qhyst_{S}

Rₙ=[Q_{map,s}+Qoffset_{S,n}−TOₙ*(1−Lₙ)]*APP_EFFECT_{UMTS}

Correspondingly, if Rₛ of the serving cell is lower than Rₙ of another cell, cell re-selection takes place.

In the above formulae

TOₙ=TEMP_OFFSETₙ*W(PENALTY_TIMEₙ−Tₙ),

W(x)=0, if x<0

W(x)=1, if x≧0.

Q_{Meas}_{_{—}}_{LEV,n,} and Q_{Meas}_{_{—}}_{LEV,S} are quality values for a received signal,

Q_{map,s} is an adjacent cell quality value,

Qhcs_{S} and Qhcsₙ are threshold values for quality,

Qhyst_{S} is a hysteresis value,

TEMP_OFFSET is a temporary offset value used for the duration of a predetermined PENALTY_TIME period

Tₙ is a timer,

Lₙ is a parameter the value of which is determined on the basis of the hierarchical levels of hierarchical cells.

The above terms are described in greater detail in standard publication 3GPP TS 25.304 v. 3.6.0, which is to be included herein by reference.

In the above formulae the term APP_EFFECT_{UMTS} represents the cell selection criterion attached to the service, which will be described below.

Let us then examine examples of possible algorithms and cell re-selection parameters for services in the GSM system. A cell re-selection criterion can be determined as follows:

From an UTRA cell is measured the value of its pilot signal RSCP (Received Signal Code Power), i.e. its power value. This power value is then multiplied by an APP_EFFECT_{GSM} parameter. Further, the user equipment measures the average received power, also referred to as RLA_C (Received Level Averages), of not only other cells but also its own cell. If the RSCP measured from the UTRA cell and multiplied by the APP_EFFECT_{GSM} parameter is higher than the RLA_C values of the surrounding GSM cells by the amount of FDD_OFFSET value during five consecutive seconds, the user equipment selects the UTRA cell. In this context, FDD_OFFSET is a system parameter.

In the above criteria, the parameter APP_EFFECT represents the cell selection parameter attached to a service and enabling, as stated, the cell selection algorithm of the user equipment to take into account the needs of an activated service with regard to cell. The decimal value of the parameter is preferably within 0.00 . . . 2.00 and it can be used, as stated, to serve as a weighting coefficient. The parameter value can be used for either increasing or decreasing the probability that a cell is changed to a cell having another radio access technology.

Assume, by way of example, that the user equipment is camped on a cell which is in a system that employs the UTRA radio access technology. When the user activates with the user equipment a service that has an APP_EFFECT parameter which is too high for the UTRA, the probability that the user equipment will change to a GSM cell is low. Correspondingly, if we assume that the APP_EFFECT parameter of the activated service is too low for the UTRA, the probability that the user equipment will change to a GSM cell is high.

In the above described example the list maintained by the user equipment comprises radio access technologies and the related parameters. Correspondingly, the list may also comprise network access technologies and the parameters related to them.

Let us then examine another preferred implementation of the invention. In this implementation the user equipment informs the telecommunications system about the activation of a service in the user equipment. The system then checks which is the most suitable access type for the service in question, and informs the access type to the user equipment. Upon receiving the information, the user equipment may, when necessary, carry out a re-selection of the access type.

With reference to FIG. 1C, the user equipment can communicate in the telecommunications system for example with an IP Multimedia Subsystem IMS. The IMS provides the radio system with multimedia services which are usually, although not necessarily, Internet-based services employing a packet protocol. In an alternative implementation, the IMS maintains a list of the services its offers and their preferred access types, which may comprise radio access or network access types, or both. To exchange messages with the IMS, the user equipment may use what is known as a Session Initiation Protocol (SIP), which is used in third generation systems for controlling calls in the packet network.

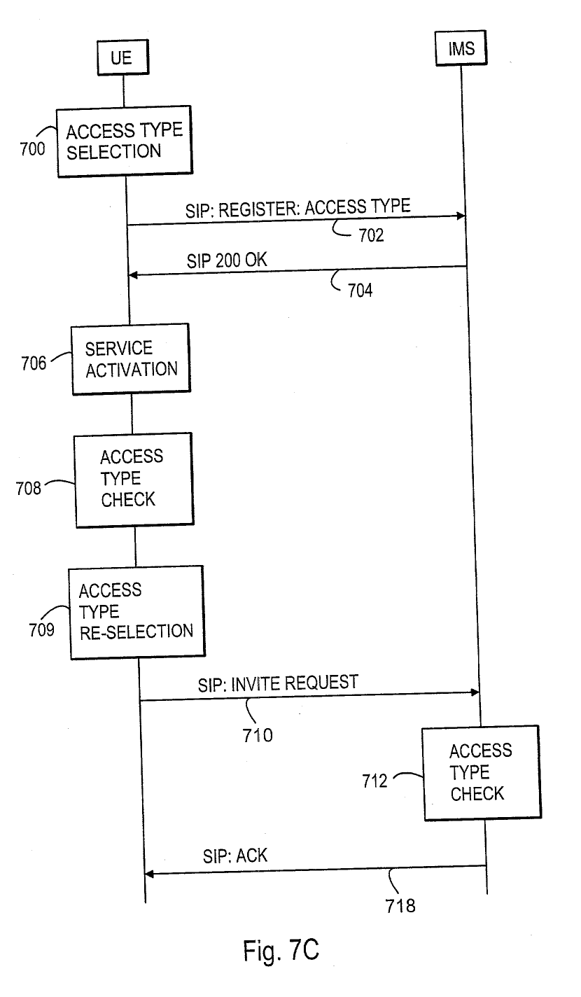

Let us then examine a signalling diagram shown in FIG. 7A. The diagram begins when the user equipment is switched on. In step 700, the user equipment searches for a cell and connects to it to contact the system. At this stage, the user equipment and the system do not know what services the user wishes to use. The cell is therefore selected using a prior art method, and the cell has a radio access type in use. The network access type, i.e. whether a packet-switched or a circuit-switched connection (PS/CS domain) is to be used, is selected similarly. The user equipment sends a SIP:REGISTER:access type message 702 to inform the IMS about the radio access type it is using. The IMS sends an acknowledgment message 704 to the user equipment. With this phase the system part responsible for providing services is thus informed of the radio access type used by the user equipment.

Assume that in the following example the user activates a service on the user equipment. Another alternative would naturally be that the service is activated from the system side. After an undefined period of time, the user activates a desired application on the user equipment in phase 706. At this stage the user equipment itself may detect the need to change the access type, according to the method of implementation described above. Let us assume, however, that this does not happen. The user equipment sends the telecommunications system a SIP:INVITE request message in step 710. The message comprises information about the service that is being activated. The system receives the message and in step 712 it checks whether the user equipment's current access type is suitable for the service activated. Assume now that another access type than the one currently used would be better suited for the service. In that case, the system sends the user equipment a message 714 SIP:OPTIONS:access type to indicate a new access type for use to the user equipment.

The user equipment receives the message in question and detects that the access type informed by the system is different than the one it is currently using. Consequently, a change of access type is initiated in step 716. The actual change does not need to be described in greater detail herein.

Let us then examine an example illustrated by a signalling diagram of FIG. 7B. Similarly as in FIG. 7A, the routine proceeds to step 712 to check whether the current access type of the user equipment is suitable for the service activated. Assume that in this example the system detects the current access type to be suitable for the activated service. Consequently, the system sends an acknowledgement message 718 SIP:ACK to the user equipment.

Next, we shall examine an example illustrated in the signalling diagram of FIG. 7C. Here the routine proceeds similarly as in FIG. 7A up to step 706 where the user activates a desired application on the user equipment. Next, the user equipment itself can check the need for a change of access type in step 708, similarly as in the above described implementation. Assume that in this example the user equipment detects that a change of access type is needed. In step 709, the user equipment can now initiate the change itself. The actual change does not need to be described in greater detail in this context. The change may involve the informing of the new access type to the system. The routine then proceeds to step 710 where the user equipment sends the telecommunications system a SIP:INVITE request message. In step 712 the system checks whether the current access type of the user equipment is suitable for the activated service. Assume that in this example the system detects the current access type to be suitable for the activated service. Consequently, the system sends an acknowledgement message 718 SIP:ACK to the user equipment.

Assume now that the service is activated on the system side. In that case the access type best suited for the service in question can be checked directly in the system, without any exchange of messages. In other words, step 712 of FIG. 7A can be executed, and in step 714 the user equipment can be informed whether the access type currently used by the user equipment needs to be changed. Upon receiving the information, the user equipment may, if necessary, carry out a re-selection of access type in step 716.

In the above description, the term ‘access type’ is used for both radio access and network access technologies. In the above examples, the changing of access type may involve both radio and network access type simultaneously, or one of them. Let us examine an example that relates to FIG. 7A. In step 700 the user equipment selects a radio or network access type. Later, in step 712, the system may indicate to the user equipment a network access type that is better suited for the service activated in the user equipment. In step 716, the user-equipment performs network access type re-selection. The radio access type, however, does not necessarily need to be reselected in this connection. Correspondingly, it is also possible to change the radio access type even if the network access type were not re-selected.

Although the invention is described above with reference to examples shown in the attached drawings, it is apparent that the invention is not restricted to them, but can vary in many ways within the inventive idea disclosed in the attached claims.

1. User equipment comprising
means for employing more than one access type to communicate with radio systems;
means for activating a service requiring a connection between the user equipment and a radio system,
means for checking the suitability of the user equipment's current access type for the operation of the activated service; and
means for carrying out a re-selection of access type, in response to the check, to select an access type suitable for the service.

2. The user equipment of claim 1, further comprising
means for maintaining a list of radio systems and their access types, the services provided by the radio systems, and cell selection parameters attached to each service,
means for carrying out measurements of the cell where the user equipment is camped on;
means for carrying out measurements of other cells in the same radio system and of cells in other radio systems;
means for carrying out a cell re-selection procedure on the basis of the measurements, instructions provided by the radio system, and the cell selection parameters attached to the activated service,
means for deciding on a cell re-selection on the basis of the procedure.

3. The user equipment of claim 1, further comprising means for using more than one radio access type for communicating with radio systems.

4. The user equipment of claim 1, further comprising means for using more than one network access type for communicating with radio systems.

5. The user equipment of claim 2, further comprising means for maintaining a list, which comprises one or more cell selection parameters in connection with each service.

6. The user equipment of claim 2, further comprising means for maintaining a list in which each service is provided with one or more cell selection parameters for each access type supported by the user equipment.

7. The user equipment of claim 2, further comprising means for occasionally executing a cell selection algorithm, a decision about cell selection being made on the basis of the algorithm, and that the means use the cell selection parameter of the activated service as a weighting coefficient in the cell selection algorithm.
